(19) United States
(12) Patent Application Publication
(10) Pub. No.: US 2004/0187002 A1
(43) Pub. Date: Sep. 23, 2004

(54) Cross-site search method and cross-site search program

(75) Inventor: Kazue Iida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/763,228

(22) Filed: Jan. 26, 2004

(30) Foreign Application Priority Data
Mar. 20, 2003 (JP) 2003-078494

(51) Int. Cl. H04L 9/00

(52) U.S. Cl. 713/175

(57) ABSTRACT

A cross-site search process reads a script definition corresponding to a search condition received from a web browser, and transmits authentication information to a target information retrieval site according to an authentication function when the script definition includes the authentication function. Receiving certification based on the authentication information, the cross-site search process receives search result from the target information retrieval site by executing functions defined in the script definition. Then, the cross-site search process responds screen data to the web browser. Accordingly, the search results matching the same search condition from all target information retrieval sites can be acquired regardless of whether an information retrieval site requires authentication or not.

### BACKGROUND OF THE INVENTION

1. Field of the Invention

The present invention relates to a cross-site search method that requests information retrieval according to a search condition designated by a user from any information retrieval sites on a network to present search results to a user, and relates to a cross-site search program that controls a computer as equipment for realizing such a cross-site search method.

2. Prior Art

As well known, on networks such as the Internet, various information retrieval sites (an Electronic Library system, a database retrieval site, and an web retrieval site, etc.) are constructed. Since these information retrieval sites are usually constructed individually, a user must access each of these sites to acquire search results from respective information retrieval sites.

However, recently, so-called cross-site search sites are constructed on the Internet. For example, “Hon no shiori/the search engine for new books, old books and secondhand books” whose URL is http://www.crypto.ne.jp /search.html that could be browsed on Feb. 24, 2003, and “WPC AENA/Ultimate weapon for finding a hotel” whose URL is http://arena.nikkeibp.co.jp/tec/web/gaz/90/that could be browsed on Feb. 24, 2003.

Such a cross-site search site enables a user to access two or more information retrieval sites by a single operation with the same search condition. In addition, when the cross-site search site accepts a search condition from a user, it requests information retrieval from respective information retrieval sites, then, it presents search results acquired from the respective information retrieval sites to the use at a time.

Incidentally, some information retrieval sites in many sites on the Internet require authentication as a condition to respond search results. Since the above-described conventional cross-site search sites did not have a function to support a site that requires authentication, such a site could not be set as a target site for information retrieval. For this reason, a user must register with the information retrieval site that requires authentication and must directly access the information retrieval site that requires authentication to acquire search results aside from access to the cross-site search site.

### SUMMARY OF THE INVENTION

The present invention is made in view of the above-described problems of the conventional method. An object of the present invention is to provide an improved cross-site search method that enables to acquire search results matching the same search condition from all target information retrieval sites regardless of whether an information retrieval site requires authentication or not. Another object of the present invention is to provide an improved cross-site search program that controls a computer as equipment for realizing such a cross-site search method.

A cross-site search method of the present invention adopts the following construction in order to achieve the above-mentioned object.

That is, the cross-site search method of the present invention is used in a server that connects to a user terminal and information retrieval sites through a network and that requests information retrieval according to a search condition designated by the user terminal to receive search results from the information retrieval sites, the method includes:

a recording step for recording a script definition in which a conversion function and an authentication function are defined for each of information retrieval sites into storage, the conversion function converting a description of a search condition in compliance with a predetermined description rule into a description in compliance with a description rule of an information retrieval site, and the authentication function being used for an authentication procedure of an information retrieval site that requires authentication as a condition to respond search results;

a reading step for reading a script definition corresponding to the target information retrieval site designated by the user terminal from the storage;

a first receiving step for receiving certification from the information retrieval site by executing the authentication function when the script definition for the information retrieval site includes the authentication function;

a converting step for converting the search condition designated by the user terminal into a search condition in compliance with a description rule of the information retrieval site by executing the conversion function in the script definition;

a first transmitting step for transmitting a search request according to the converted search condition to the target information retrieval site;

a second receiving step for receiving search results from the information retrieval site that has retrieved information in response to the search request; and

a second transmitting step for transmitting the received search results to the user terminal.

With this construction, when any one information retrieval site and a search condition are designated by any one user terminal, the server requests information retrieval from an information retrieval site according to the script definition. When the information retrieval site requires authentication as a condition to respond search results, the server requests the information retrieval after a predetermined authentication procedure. On the other hand, when the information retrieval site does not require authentication, the server directly requests information retrieval without an authentication procedure.

Therefore, an operator of a user terminal is able to acquire search results matching the same search condition from all target information retrieval sites regardless of whether an information retrieval site requires authentication or not.

Further, according to the cross-site search method of the present invention, the storage of the server may store a table that defines a relationship between predetermined sets of authentication information assigned to the server by the information retrieval site that restricts the access number by assigning predetermined sets of authentication information to a source of an information retrieval request and ID information to identify whether the authentication information is used or not for each information retrieval site that restricts the access number.

With this construction, when an authentication function is defined in the script definition corresponding to the information retrieval site designated by any one user terminal, the server reads the table corresponding to the information retrieval site from the storage according to the authentication function, and identifies unassigned authentication information based on the ID information in the table read from the storage. Then the server can transmit the identified authentication information to the information retrieval site to acquire certification from the information retrieval site. Therefore, if an information retrieval site requiring authentication restricts the access number by assigning a predetermined sets of authentication information to a source of information retrieval in advance, an operator of a user terminal can acquire search results from such an information retrieval site through the server.

Further, the cross-site search program of the present invention adopts the following construction in order to achieve the above-mentioned object.

That is, the cross-site search program of the present invention operates a computer that connects to a user terminal and information retrieval sites through a network, the program includes:

a step for accepting a designation of any one information retrieval site with a search condition by any one user terminal;

a step for identifying the script definition corresponding to the target information retrieval site designated by the user terminal in a number of script definitions each of which defines a conversion function to convert a description of a search condition in compliance with a predetermined description rule into a description in compliance with a description rule of an information retrieval site;

a step for receiving certification from the information retrieval site by executing an authentication function when the identified script definition includes the authentication function because the information retrieval site requires authentication as a condition to respond search results;

a step for converting the search condition designated by the user terminal into a search condition in compliance with a description rule of the information retrieval site by executing the conversion function in the script definition;

a step for transmitting a search request according to the converted search condition to the target information retrieval site;

a step for receiving search results from the information retrieval site that has retrieved information in response to the search request; and

a step for transmitting the received search results to the user terminal.

According to the cross-site search program can operate a computer as a device executing the above-described cross-site search method.

### DESCRIPTION OF THE ACCOMPANYING DRAWINGS

FIG. 1 is a block diagram showing a general construction of a cross-site search system according to an embodiment;

FIG. 2 is a table showing a data structure of an authentication information table;

FIG. 3 is a list of one example of a script definition;

FIG. 4 is a flow chart showing contents of an web server process;

FIG. 5 is a flow chart showing contents of a cross-site search CGI process;

FIGS. 6 and 7 are flow charts showing contents of a script definition interpretation process; and

FIG. 8 is a diagram showing the example of a search item input screen.

### DESCRIPTION OF THE PREFERRED EMBODIMENTS

Hereinafter, an embodiment of the present invention will be described with reference to the drawings.

<About System Configuration>

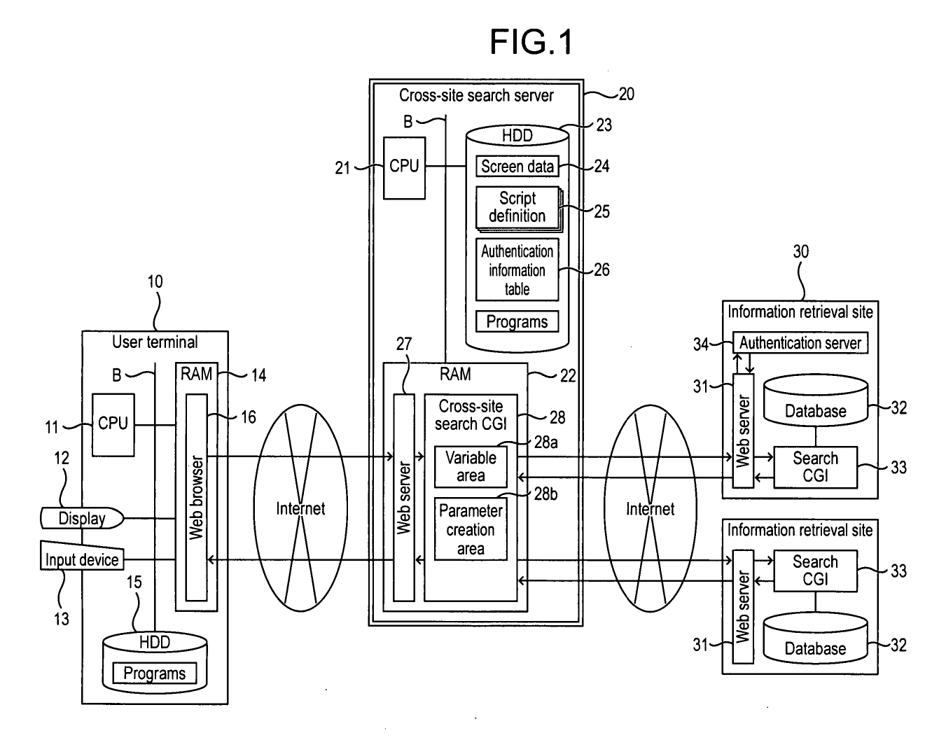

FIG. 1 is a block diagram showing a general construction of a cross-site search system according to the embodiment. As shown in FIG. 1, the cross-site search system is provided with a user terminal 10, a cross-site search server 20 and a number of information retrieval sites 30. The terminal 10, the server 20 and the sites 30 are mutually connected through the Internet so as to enable socket communication.

A user gives a search request from his or her own user terminal 10 to the cross-site search server 20, and the cross-site search server 20 searches the information retrieval sites based on the requested search condition. Next, the terminal 10, the server 20 and the site 30 will be described, respectively.

The user terminal 10 is a computer used as an Internet client machine. The user terminal 10 consists of a CPU (Central Processing Unit) 11, a communication adapter (not shown), a display 12, an input device 13, a RAM (Random Access Memory) 14 and an HDD (Hard Disk Drive) 15. These parts of the hardware are mutually connected by a bus B.

The CPU 11 is a central processing unit that controls the entire system of the user terminal 10.

Moreover, the communication adapter (not shown) is a communication device functioning as an interface with a line connected to the Internet. Specifically, it is a modem, a TA (Terminal Adapter), a router, a LAN (Local Area Network) connection board, or the like.

The display 12 is a device for displaying an image generated by CPU 11. Specifically, it is a cathode-ray tube display or a liquid crystal display.

The input device 13 is a device for receiving input from an operator. Specifically it is a keyboard, a mouse and a touch screen.

The RAM 14 is a main memory on which a work area is developed when the CPU 11 executes various programs.

The HDD 15 is storage for storing various programs that are loaded by the CPU 11 onto the RAM 14 and that are executed. The HDD 15 stores a basic program including a function of communication with the cross-site search server 20 through the communication adapter according to TCP/IP (Transmission Control Protocol/Internet Protocol), a WWW (World Wide Web) browser (referred to as a “web browser”) 16 that transmits various HTTP (Hyper Text Transfer Protocol) requests to the cross-site search server 20 using the communication function of the basic program and displays web contents (web page based on HTML (Hyper Text Mark-up Language) data or the like) by interpreting the HTTP response transmitted from the cross-site search server 20 in response to the requests.

Since the web browser 16 is a generally delivered program such as the Internet Explorer (trademark of U.S. Microsoft Corp.) of U.S. Microsoft Corp. or the Netscape Navigator (trademark of U.S. Netscape Communications) of U.S. Netscape Communications, a detailed description is omitted.

In addition, although only one user terminal 10 is illustrated in FIG. 1, two or more user terminals 10 exist in fact. That is, the user terminal 10 means every computer that can connect with the Internet and has a web browsing function.

The cross-site search server 20 is a computer used as an Internet server. The cross-site search server 20 consists of a CPU 21, a communication adapter (not shown), a RAM 22 and an HDD 23. These parts of the hardware are mutually connected by a bus B.

The CPU 21 is a central processing unit that controls the entire system of the cross-site search server 20. Further, the communication adapter (not shown) is a communication device functioning as an interface with a line (it may be a backbone line in some cases) connected to the Internet.

The RAM 22 is a main memory on which a work area is developed when the CPU 21 executes various processes.

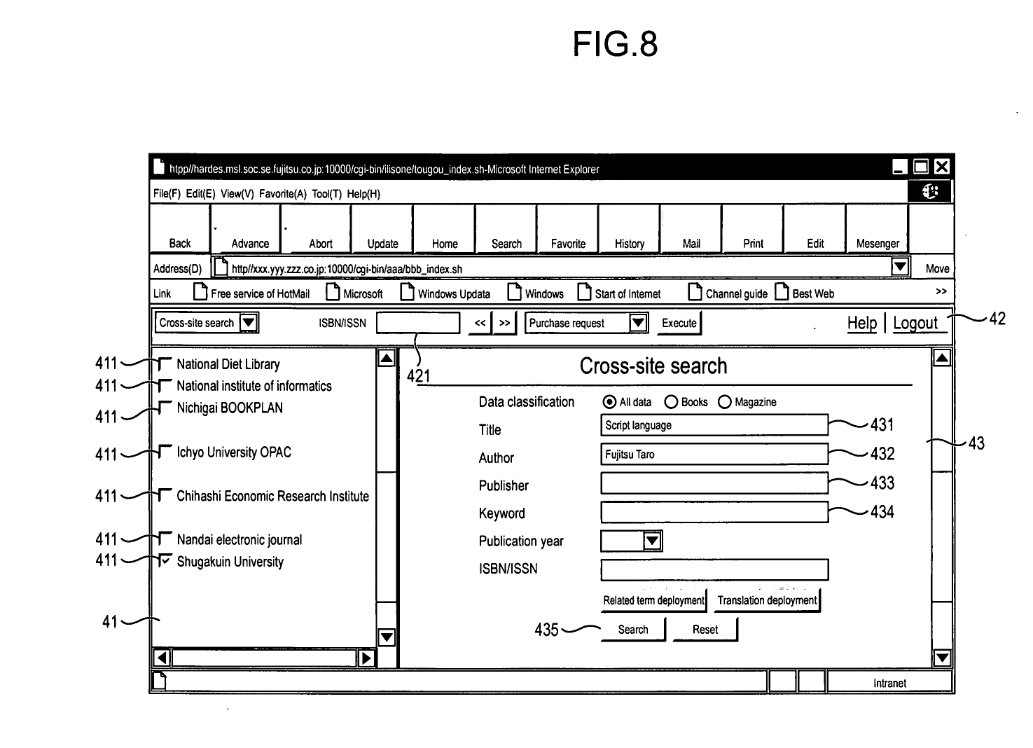

The HDD 23 is storage for storing various programs that are read by the CPU 21 onto the RAM 22 to be executed and various data. The HDD 23 stores the screen data 24 (HTML data etc.) to display various screens (a search item input screen shown in FIG. 8, for example) on the web browser 16, the same number of script definitions 25 (it will be described below with reference to FIG. 3) as the information retrieval sites 30 and the same number of authentication information table 26 as the information retrieval sites 30 that require authentication.

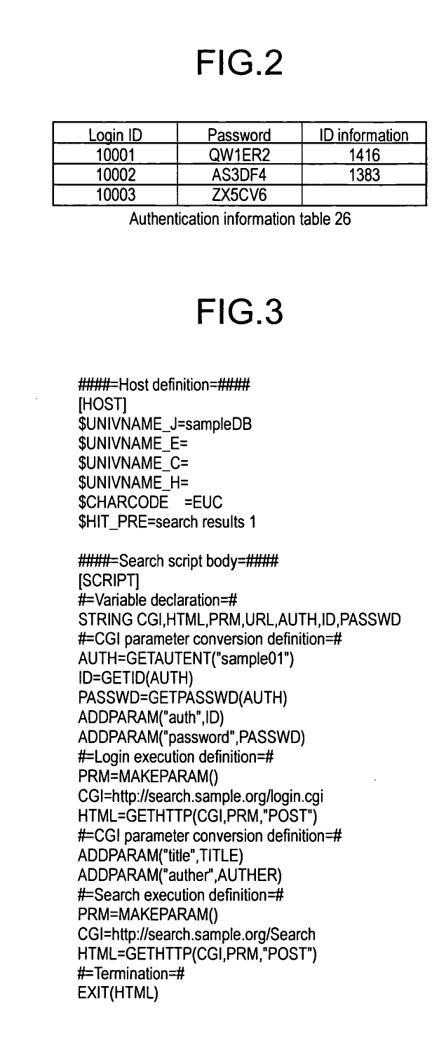

FIG. 2 is a table for describing the data structure of the authentication information table 26. As shown in FIG. 2, the authentication information table 26 is constituted by creating a record that includes fields of “login ID”, “password” and “ID information” for each authentication information (a combination of the “login ID” and “password”). The login ID and the password assigned to the cross-site search server 20 by the information retrieval site 30 that requires authentication as a condition to respond search results are recorded in the fields of “login ID” and “password”, respectively.

In addition, the authentication information table 26 of FIG. 2 shows that three sets of authentication information (combinations of login ID and password) are assigned to the cross-site search server 20.

Process ID assigned to the below-mentioned cross-site search CGI (Common Gateway Interface) program 28 at the time of execution is recorded in the “ID information” field. A process means the management unit of the program execution when the CPU 21 assigns a working area in the RAM 22 to one CGI program to execute. And the process ID means information for uniquely identifying many running processes, respectively. That is, when the cross-site search CGI program 28 to which process ID is assigned is executed and uses login ID and a password, the process ID in question is recorded in the “ID information” field of the record whose contents in the “login ID” field and the “password” field match the used login ID and password, respectively. However, when the combination of login ID and a password has never been used in any process, the “ID information” field of the record remains as a blank field.

Moreover, the HDD 23 stores a WWW server (referred to as an web server hereinafter) program 27 and the cross-site search CGI program 28 in addition to the basic program for supporting TCP/IP. The web server program 27 responds by reading screen data 24 indicated by URL (uniform Resource Locator) that is designated by an HTTP request from the web browser 16 from the HDD 23, and it starts a CGI program indicated by the requested URL. The cross-site search CGI program 28, which is one of CGI programs, makes the CPU 21 execute functions defined in the script definition 25. The contents of the program 28 will be described later with reference to FIG. 5.

The information retrieval site 30 searches its own database for predetermined information in response to the request from a computer on the Internet, such as the cross-site search server 20, and returns the search results to the computer. The functions of the information retrieval site 30 is realized on a computer connected with the Internet. That is, the information retrieval site 30 means a server computer including storage such as an HDD that stores the web server program 31, the database 32 to be searched and the search CGI program 33 for searching the database 32, and a CPU that executes the various programs 31 and 33 in abroad sense. On the contrary, the information retrieval site 30 means the search CGI program 33 in a narrow sense. In addition, FIG. 1 shows the information retrieval sites 30 at two places, but they exist at more places in fact. Moreover, some information retrieval sites in many sites on the Internet require authentication as a condition to respond search results. In the information retrieval sites 30 that require authentication, storage such as an HDD stores an authentication server program 34 and an authentication table (not shown) in addition to the search CGI program 33.

When the authentication server program 34, that is, the CPU of the information retrieval site 30 executing the program 34, receives the login ID and the password assigned to the cross-site search server 20 from this server 20 through the function of the web server program 31, it judges whether a combination of the login ID and the password can be authenticated or not. Then, the authentication server program 34 permits execution of the search CGI program 33, when the combination can be authenticated (when the combination exists in the authentication table). When the combination cannot be authenticated, the program 34 bars execution of the search CGI program 33 and informs such a result to the cross-site search server 20 through the function of the web server program 31.

Further, the information retrieval sites 30 that require authentication can be distinguished into two groups. The information retrieval sites 30 belonging to the first group restrict the access number by assigning predetermined sets of authentication information to computers on the network. The above-mentioned authentication information table 26 is prepared for such a site by assigning some sets of authentication information to the cross-site search server 20.

The information retrieval sites 30 belonging to the second group provide one set of authentication information that is shared by the respective computers on the network and give notice of the authentication information in response to a request. Since an information retrieval site of the second group uses the authentication information in order to acquire the information about users, it accepts all accesses from the computers of the users who got the authentication information and executes a search. For this reason, the information retrieval sites 30 of the second group do not substantially restrict the number of accesses.

<About Script Definition>

FIG. 3 is an example of the script definition 25 used when the cross-site search server 20 searches the information retrieval site 30. This script definition is an example in case the information retrieval site 30 requires authentication. That is, FIG. 3 is an example of the script definition prepared for the cross-site search server 20 when the information retrieval site 30 searches the database by the search CGI program 33 and authenticates by the authentication server program 34.

As shown in FIG. 3, the script definition 25 consists of a host definition that defines information required before and after the information retrieval request in the corresponding information retrieval site 30, and a search script body for specifying the contents of the search.

In addition, since the host definition is not related to the present invention, it will be described briefly. The host definition defines the character code set at the information retrieval site 30 corresponding to the script definition 25, a method to acquire search results, and the display name in a search result screen (not shown), or the like.

On the other hand, the search script body includes a variable definition that describes variables used in the script definition 25, a CGI parameter conversion definition that describes the functions for acquiring the login ID and password required for the authentication when the information retrieval site 30 requires authentication, a login execution definition that describes the functions for transmitting the login ID and password to the information retrieval site 30, a CGI parameter conversion definition that describes the functions for converting the search condition input in the below-mentioned search item input screen (refer to FIG. 8) in compliance with the description rule of the information retrieval site 30, and a search execution definition that describes the functions for transmitting a search execution request message to the information retrieval site 30.

Hereinafter, the functions GETAUTHENT( ), GETID( ), GETPASSWD( ), ADDPARAM( ), MAKEPARAM( ), and GETHTTP( ), which can be defined in the respective script definitions 25, will be described with their forms.

1. GETAUTHENT(File Name of Authentication Information Table)

This function reads the authentication information (login ID and password) that is not used by the currently executed cross-site search CGI program 28 from the authentication information table 26 designated by the file name. In the script definition 25 shown in FIG. 3, since it is defined as AUTH=GETAUTHENT(“sample01”), the cross-site search CGI program 28 according to the function GETAUTHENT ( ) reads the authentication information that is not used by the other cross-site search CGI programs 28 under execution from the authentication information table 26 whose file name is “sample01”. Then the program 28 substitutes the authentication information to the variable AUTH and stores it in the variable area 28a.

2. GETID(Variable)

This function reads login ID from the information substituted to the variable. In the script definition 25 shown in FIG. 3, since it is defined as ID=GETID(AUTH), the cross-site search CGI program 28 according to the function GETID( ) reads the login ID from the authentication information substituted to the variable AUTH. Then the program 28 substitutes the login ID to the variable ID and stores it in the variable area 28a.

3. GETPASSWD(Variable)

This function reads a password from the information substituted to the variable. In the script definition 25 shown in FIG. 3, since it is defined as PASSWD=GETPASSWD (AUTH), the cross-site search CGI program 28 according to the function GETPASSWD( ) reads the password from the authentication information substituted to the variable AUTH. Then the program 28 substitutes the password to the variable PASSWD and stores it in the variable area 28a.

4. ADDPARAM(Attribute Value of NAME Attribute, Variable)

This function adds the argument information that consists of an attribute value of a NAME attribute and information substituted to the variable to the end of a parameter creation area 28b. In the script definition 25 shown in FIG. 3, since it is defined as ADDPARAM(“auth”, ID), assuming that “10001” is substituted to the variable ID, the cross-site search CGI program 28 according to the function ADDPARAM( ) adds the argument information “auth=10001” to the end of the parameter creation area 28b. Further, since it is defined as ADDPARAM(“password”, PASSWD) in this script definition 25, assuming that “QW1ER2” is substituted to the variable PASSWD, the cross-site search CGI program 28 according to the function ADDPARAM( ) adds the argument information “password=QW1ER2” to the end of parameter creation area 28b.

Furthermore, since it is defined as ADDPARAM (“title”, TITLE) and ADDPARAM (“auth”, AUTHER) in the script definition 25, if, for example, “script language” and “Fujitsu Taro” are input into the title column 431 and the author column 432 of the search item input screen (see FIG. 8), respectively, and when the search condition acquired from the web browser 16 on the variable area 28a shows “TITLE=script language” and “AUTHER=Fujitsu Taro”, the cross-site search CGI program 28 according to the function ADDPARAM( ) adds the argument information of “title=script language” and “auth=Fujitsu Taro” to the end of the parameter creation area 28b.

5. MAKEPARAM( )

This function converts the information stored in the parameter creation area 28b into the form that is suitable to pass to the information retrieval site 30. With the example used in the description of the function ADDPARAM( ), the cross-site search CGI program 28 according to the function MAKEPARAM( ) reads “auth=10001” and “password=QW1ER2” from the parameter creation area 28b, connecting them by “&” as “auth=10001&password=QW1ER2”. In addition, since the script definition 25 of FIG. 3 defines PRM=MAKEPARAM( ), the cross-site search CGI program 28 according to the function MAKEPARAM( ) substitutes the information made by combining many pieces of argument information into the variable PRM and stores it in the parameter creation area 28b.

6. GETHTTP(First Variable, Second Variable, Name of Transmitting Method)

This function transmits the information substituted into the second variable to the destination address indicated by the information substituted into the first variable by the transmitting method indicated by the name of the transmitting method. Since the script definition 25 shown in FIG. 3 defines GETHTTP(CGI, PRM, “POST”), the cross-site search CGI program 28 according to the function GETHTTP( ) gives a direction to the web server program 27 so that one or more pieces of the argument information substituted into the variable PRM is transmitted to the URL substituted into the variable CGI by the POST method.

<About the Contents of Process>

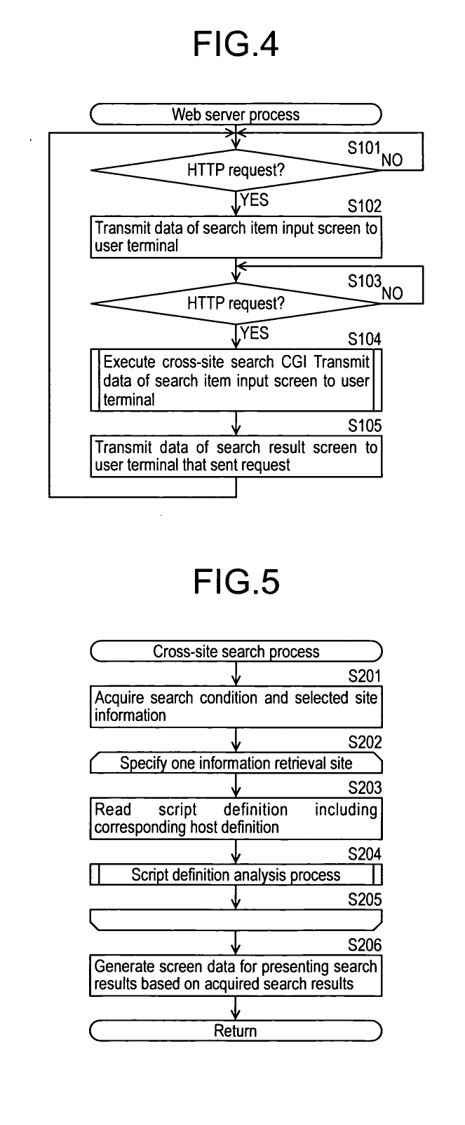

Next, the process executed in the above-constructed cross-site search system will be described with reference to flow charts shown in FIG. 4 through FIG. 7.

The contents of web server process will be described based on FIG. 4. First, in the cross-site search server 20, when the CPU 21 reads and executes the web server program 27, the CPU 21 realizes the function as a web server. Hereinafter, the reference “27” is given to the web server. At the first step S101 in the flow chart shown in FIG. 4, the web server 27 stands by until receiving an HTTP request from the web browser 16 of any one of the user terminals 10.

On the other hand, when an operator operates the input device 13 of the user terminal 10 to start the web browser and to access the cross-site search site on the cross-site search server 20, the web browser 16 (the CPU 11 executes the browser program) of the user terminal 10 transmits an HTTP request to the cross-site search server 20. Then, the web server 27 of the cross-site search server 20 that received the HTTP request advances the process to S102.

At S102, the web server 27 transmits the HTTP response that contains the screen data of the search item input screen in its body to the user terminal 10 that sent the request. The web browser 16 that received the screen data (HTML data) displays the search item input screen on the display 12. FIG. 8 is an example of the search item input screen. The search item input screen is divided into a first frame 41 that includes a number of check boxes 411 corresponding to the respective information retrieval sites 30, a second frame 42 that includes an “ISBN/ISSN” column 421, and a third frame 43 that includes a “title” column 431, an “author” column 432, a “publisher” column 433, a “keyword” column 434 and a “search” button 435.

Further, in the screen data for displaying the contents of the third frame 43, the item name of “TITLE” is set in NAME attribute of the <input> tag for displaying the “title” column 431, the item name of “auth” is set in NAME attribute of the <input> tag for displaying the “author” column 432, the item name of “pub” is set in NAME attribute of the <input> tag for displaying the “publisher” column 433, and the item name of “keyword” is set in NAME attribute of the <input> tag for displaying the “keyword” column 434. These attributes are not shown in FIG. 8. Furthermore, the screen data is provided with <form> tags for transmitting the information inputted into the text boxes displayed on the screen by the respective <input> tags. The description to pass the argument generated by the <input> tag to the cross-site search server 20 by the POST method has been recorded in the ACTION attribute of the <form> tag.

Therefore, when a user (an operator of the user terminal 10) operates the mouse to move the pointer over the “search” button 435 and left-cricks, or when the user operates arrow keys to move the cursor over the “search” button 435 and presses an enter key, the search condition and site information of the selected information retrieval site 30 are transmitted to the web server 27 of the cross-site search server 20 by the POST method. The search condition includes combinations of the item names of the respective columns 431 through 434 and the values input in the respective columns by the user (item name =value). The information retrieval site 30 is selected based on the check marks input in the respective check boxes in the first frame 41 and the information of the selected site is transmitted as the selected site information.

On the other hand, the web server 27 advances the process from S102 to S103 after transmitting the screen data of the search item input screen to the web browser 16 of user terminal 10 at S102. At S103, the web server 27 stands by until receiving an HTTP request from the web browser 16 of the user terminal 10. Then, the web server 27 advances the process to S104, if it receives the search conditions and the selected site information as an argument with the HTTP request from the web browser 16.

At S104, the web server 27 reads the cross-site search CGI program 28 indicated by the URL in the HTTP request to start a cross-site search process and passes over the search conditions and the selected site information to the cross-site search process. Hereinafter, a reference “28” is given to the cross-site search process.

Next, the contents of the cross-site search process 28 will be described with reference to FIG. 5. The cross-site search process 28 acquires the search conditions and the selected site information from the web server 27 at the first step S201 in the flow chart shown in FIG. 5. Then, the cross-site search process 28 performs the following loop process (S202 through S205) with respect to one or more information retrieval sites 30 designated by the selected site information (that is., the information retrieval site(s) 30 whose corresponding check box 411 in the first frame 41 of the search item input screen of FIG. 8 was marked with the check mark).

At S202, the cross-site search process 28 specifies one information retrieval site 30 as a target of the process from the selected one or more information retrieval sites 30.

At S203, the cross-site search process 28 reads the script definition 25 corresponding to the target information retrieval site 30 from the HDD 23.

At the next step S204, the cross-site search process 28 executes the below-mentioned script definition analysis process for the read script definition 25 and advances to S205 after finishing the script definition analysis process.

At S205, the cross-site search process 28 specifies the next information retrieval site 30 as a target for processing.

The cross-site search process 28 executes the above process loop from S202 to S205 repeatedly for all of the selected information retrieval sites 30.

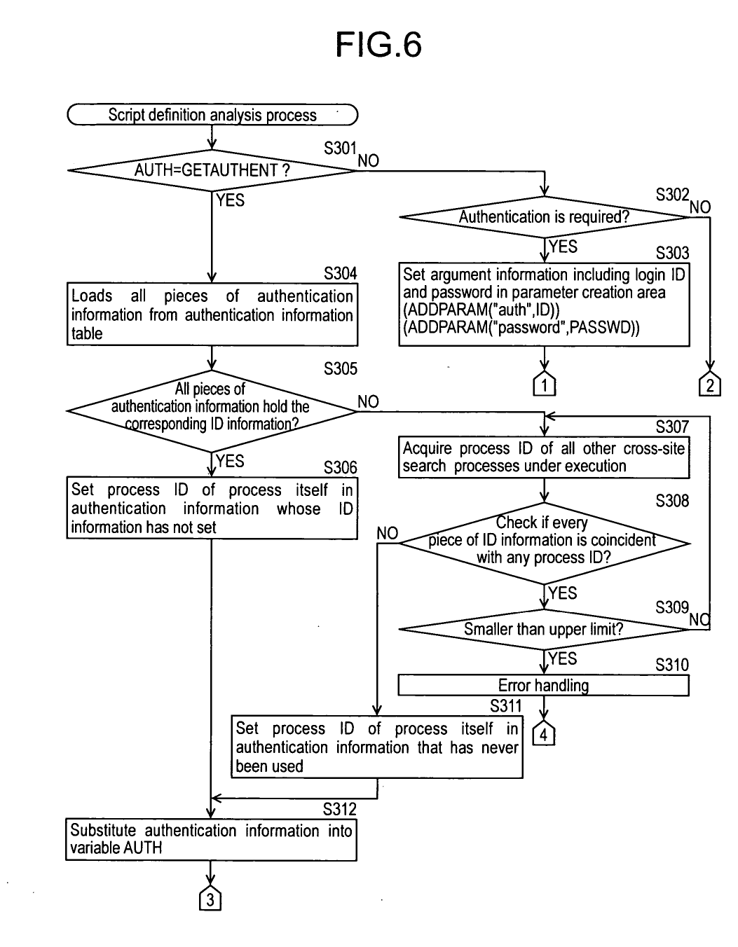

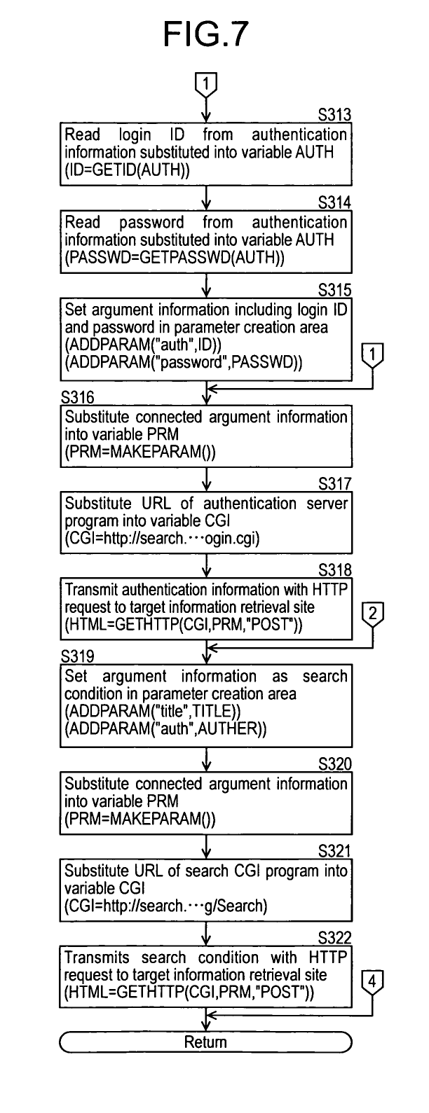

Next, the script definition analysis process that is repeatedly executed at S204 in the loop process will be described with reference to FIG. 6 and FIG. 7. At S301, the cross-site search process 28 judges the presence or absence of AUTH=GETAUTHENT( ). When AUTH=GETAUTHENT( ) does not exist in the script definition 25, the cross-site search process 28 advances to S302.

At S302, the cross-site search process 28 judges whether the target information retrieval site 30 requires authentication or not. If the target information retrieval site 30 requires authentication, the cross-site search process 28 judges that this information retrieval site 30 requires authentication and does not restrict the access number, the process 28 advances to S303.

At S303, the cross-site search process 28 substitutes one set of the login ID and the password described in the script definition 25 into the variables ID and PASSWD, respectively, based on the premise that this information retrieval site 30 is assigned to the cross-site search server 20 (and to another computer). Then, the process 28 adds the argument information to the end of the parameter creation area 28b and advances to S316. The argument information consists of the attribute value (item name) of the NAME attribute used by this information retrieval site 30 and the information substituted into the variable ID or the variable PASSWD.

On the other hand, if it is judged that the target information retrieval site 30 does not require authentication at S302, not executing a series of steps based on the function for the authentication, the cross-site search process 28 advances to S319. In addition, the functions equivalent to the steps of S302 and S303 are not illustrated in an example of the script definition 25 shown in FIG. 3.

Further, if it is judged that AUTH=GETAUTHENT( ) exists in the script definition 25 at S301, the cross-site search process 28 judges that the target information retrieval site 30 requires authentication and restricts the access number. Then, the process 28 executes the steps from S304 to S311 according to the function GETAUTHENT( ).

At S304, the cross-site search process 28 loads all pieces of authentication information and ID information from the authentication information table 26 that is indicated by the file name defined in the function GETAUTHENT( ) into the variable area 28a.

At the next step S305, the cross-site search process 28 distinguishes whether all pieces of the authentication information hold the corresponding ID information or not. That is, the cross-site search process 28 checks whether process ID is recorded in the “ID information” of every record of the authentication information table 26 for this information retrieval site 30 or not. If at least one piece of authentication information does not hold the corresponding ID information, that is, if the “ID information” field of at least one record of the authentication information table 26 for this information retrieval site 30 is blank, the cross-site search process 28 advances to S306.

At S306, the cross-site search process 28 sets the process ID currently assigned to itself to one piece of the authentication information whose ID information has not set, stores this process ID into the “ID information” field of the record holding the authentication information in question in the authentication information table 26, and advances to S312.

On the other hand, when all pieces of the authenticate information hold the corresponding ID information at S305, i.e., when there is no record having a blank “ID information” field in the authentication information table 26 for this information retrieval site 30, the cross-site search process 28 advances to S307.

At S307, the cross-site search process 28 acquires the process ID of all other cross-site search processes 28 under execution, and advances to S308.

At S308, the cross-site search process 28 checks whether every piece of the ID information read at S304 is coincident with any process ID acquired at S307 or not. When the every piece of the ID information read at S304 is coincident with any process ID acquired at S307, the cross-site search process 28 advances to S309.

At S309, the cross-site search process 28 distinguishes whether the number of times of execution of S307 and S308 reached a predetermined upper limit or not. If the number of times of execution has not reached the predetermined upper limit, the cross-site search process 28 returns to S307.

During execution of the process loop S307 through S309, when the number of times of execution of S307 and S308 reaches the above-mentioned predetermined upper limit, the cross-site search process 28 branches from S309 to S310.

At S310, the cross-site search process 28 judges certification cannot be acquired from this information retrieval site 30 and executes error handling for canceling the information retrieval request from this information retrieval site 30. Then, the process 28 finishes the script definition analysis process.

On the other hand, during execution of the process loop S307 through S309, when the ID information that is not coincident with any process ID is found before the number of times of execution of S307 and S308 reaches the above-mentioned predetermined upper limit, the cross-site search process 28 branches from S308 to S311.

At S311, the cross-site search process 28 sets the process ID currently assigned to itself as new ID information of the authentication information corresponding to the found ID information and overwrites the “ID information” field of the record including the authentication information in question in the authentication information table 26 with this process ID. Then, the process 28 advances to S312.

At S312, the cross-site search process 28 substitutes the authentication information into the variable AUTH and stores it in the variable area 28a. Then, the process 28 advances to S313.

At S313, the cross-site search process 28 reads login ID from the authentication information substituted into the variable AUTH, substitutes this login ID into the variable ID, and stores it in the variable area 28a. Then the process 28 advances to S314.

At S314, the cross-site search process 28 reads a password from the authentication information substituted into the variable AUTH, substitutes this password into the variable PASSWD, and stores it in the variable area 28a. Then, the process 28 advances to S315.

At S315, the cross-site search process 28 stores the argument information having the login ID (it will be “auth”=10001 in the example used in the description of the script definition) and the argument information having the password (it will be “password”=QW1ER2 in the example used in the description of the script definition) into the parameter creation area 28b.

At the next step S316, the cross-site search process 28 reads the argument information from the parameter creation area 28b, converts the information by connecting the items in the information by “&”, substitutes the converted information into the variable PRM and stores it in the parameter creation area 28b.

At the next step S317, the cross-site search process 28 substitutes the URL of the authentication server program 34 described in the script definition 25 corresponding to the target information retrieval site 30.

At the next step S318, the cross-site search process 28 transmits the argument information as the authentication information with the HTTP request to the target information retrieval site 30 through the web server 27, and stands by until a predetermined HTTP response including a message of success in authentication is received from this information retrieval site 30. Receiving the HTTP response through the web server 27, the cross-site search process 28 advances to S319.

At S319, the cross-site search process 28 converts the item names included in the search conditions received as arguments at S103 into the item names that are used in the target information retrieval site 30, and stores them into the parameter creation area 28b.

At the next step S320, the cross-site search process 28 converts the argument information in the parameter creation area 28b by connecting the respective items by “&”, substitutes the converted information into the variable PRM, and stores it in the parameter creation area 28b.

At the next step S321, the cross-site search process 28 substitutes the URL of the search CGI program 33 described in the script definition 25 corresponding to the target information retrieval site 30 into the variable CGI.

At the next step S322, the cross-site search process 28 transmits the argument information as the search conditions with the HTTP request to the target information retrieval site 30 through the web server 27, and stands by until a predetermined HTTP response including search results is received from this information retrieval site 30. Receiving the HTTP response through the web server 27, the cross-site search process 28 finishes the script definition analysis process.

The cross-site search process 28 repeatedly executes the above-described script definition analysis process for each of one or more selected information retrieval sites 30 during the process loop S202 through S205 of FIG. 5 and acquires the search results from the respective information retrieval sites 30. Then, escaping from the process loop, the cross-site search process 28 generates the screen data for presenting the search results based on the acquired search results at S206 and then passes the screen data to the web server 27, thereby the cross-site search process 28 is completed.

Receiving the screen data, the web server 27 transmits an HTTP response including the screen data in its body to the web browser 16 of the user terminal 10 that has requested the information retrieval. Then the web server 27 returns the process to S101 and stands by until receiving the next HTTP request. In addition, the web browser 16 of the user terminal 10 that received the screen data displays the search result screen on the display 12 based on the screen data.

<About Operation>

Since the above-described processes are executed in the cross-site search system of the embodiment, the cross-site search system operates as follows.

When a user inputs a search condition once according to a predetermined form to select information retrieval sites 30 as destination sites, the cross-site search server 20 requests information retrieval after a predetermined authentication procedure from the information retrieval sites 30 that require authentication as a condition to respond search results (S302: Yes, S303 through S322), or directly requests information retrieval without the authentication procedure from the information retrieval sites 30 that does not require authentication (S302: No)

Further, for the information retrieval sites 30 that restrict the access number by assigning predetermined sets of authentication information to a source of an information retrieval request, the cross-site search server 20 uses the authentication information table 26 to manage whether the cross-site search process 28 uses the authentication information assigned by the information retrieval sites 30 or not. Then, the respective cross-site search processes 28 of the cross-site search server 20 find and use the authentication information not in active use (S305: No, S306). When the all pieces of the authentication information are actually used, the process 28 waits for a predetermined period (S305: Yes, S307 through S309). And if any one piece of the authentication information is released, the process 28 uses the released authentication information (S308: Yes, S311).

As a result, since the respective cross-site search processes 28 repeatedly use the authentication information not in actual use, the cross-site search server 20 can acquires the search result from the information retrieval sites 30 even if the information retrieval sites restrict the access number.

As described above, the present invention enables to acquire search results matching the same search condition from all target information retrieval sites regardless of whether an information retrieval site requires authentication or not.

What is claimed is:

1. A cross-site search method used in a server that connects to a user terminal and information retrieval sites through a network and that requests information retrieval according to a search condition designated by said user terminal to receive search results from said information retrieval sites, said method comprising:
recording a script definition in which a conversion function and an authentication function are defined for each of information retrieval sites into storage, said conversion function converting a description of a search condition in compliance with a predetermined description rule into a description in compliance with a description rule of an information retrieval site, and said authentication function being used for an authentication procedure of an information retrieval site that requires authentication as a condition to respond search results;
reading a script definition corresponding to the information retrieval site designated by the user terminal from said storage;
receiving certification from the information retrieval site by executing the authentication function when the script definition for the information retrieval site includes the authentication function;
converting said search condition designated by the user terminal into a search condition in compliance with a description rule of the information retrieval site by executing the conversion function in the script definition;
transmitting a search request according to the converted search condition to the designated information retrieval site;
receiving search results from the information retrieval site that has retrieved information in response to said search request; and
transmitting the received search results to the user terminal.

2. The cross-site search method according to claim 1, further comprising:
recording predetermined sets of authentication information and ID information into said storage for each information retrieval site when the information retrieval site requires authentication and restricts the access number by assigning predetermined sets of authentication information to a source of an information retrieval request, said authentication information being assigned to said server by said information retrieval site, and said ID information identifying whether said authentication information is used or not;
identifying unassigned authentication information based on the ID information read from said storage corresponding to said information retrieval site; and
transmitting the identified authentication information to said information retrieval site to receive the certification from said information retrieval site.

3. The cross-site search method according to claim 1, further comprising:
transmitting authentication information assigned by an information retrieval site to said information retrieval site according to an authentication function to receive certification from said information retrieval site when the script definition for said information retrieval site includes said authentication function.

4. The cross-site search method according to claim 1, wherein the communication between said server and said user terminal, and the communication between said server and said information retrieval sites use TCP/IP and HTTP, respectively.

5. A cross-site search program used in a server that connects to a user terminal and information retrieval sites through a network and that requests information retrieval according to a search condition designated by said user terminal to receive search results from the information retrieval sites, said program causing said server to execute the procedures of:
recording a script definition in which a conversion function and an authentication function are defined for each of information retrieval sites into storage, said conversion function converting a description of a search condition in compliance with a predetermined description rule into a description in compliance with a description rule of an information retrieval site, and said authentication function being used for an authentication procedure of an information retrieval site that requires authentication as a condition to respond search results;
reading a script definition corresponding to the information retrieval site designated by the user terminal from said storage;
receiving certification from the information retrieval site by executing the authentication function when the script definition for the information retrieval site includes the authentication function;
converting said search condition designated by the user terminal into a search condition in compliance with a description rule of the information retrieval site by executing the conversion function in the script definition;
transmitting a search request according to the converted search condition to the designated information retrieval site;
receiving search results from the information retrieval site that has retrieved information in response to said search request; and
transmitting the received search results to said user terminal.

6. The cross-site search program according to claim 5, wherein said program is a CGI program.

7. A cross-site search program running on a computer connected to a user terminal and a number of information retrieval sites through a network, said program causing said computer to execute the procedures of:
accepting designation of any one of said information retrieval sites with a search condition by said user terminal;
identifying a script definition corresponding to the designated information retrieval site among a number of script definitions, said script definition defining a conversion function that converts a description of a search condition in compliance with a predetermined description rule into a description in compliance with a description 41 rule of an information retrieval site;
receiving certification from the information retrieval site by executing an authentication function when the script definition for said information retrieval site includes said authentication function;
converting the search condition designated by the user terminal into a search condition in compliance with a description rule of the information retrieval site by executing the conversion function in the script definition;
transmitting a search request according to the converted search condition to the designated information retrieval site;
receiving search results from the information retrieval site that has retrieved information in response to said search request; and
transmitting the received search results to said user terminal.

8. A server that connects to a user terminal and information retrieval sites through a network and that requests information retrieval according to a search condition designated by said user terminal to receive search results from the information retrieval sites, said server comprising:
receiving means that receive said search condition from said user terminal;
recording means that record a script definition in which a conversion function and an authentication function for each of information retrieval sites into storage, the conversion function converting a description of a search condition in compliance with a predetermined description rule into a description in compliance with a description rule of an information retrieval site, and the authentication function being used for an authentication procedure of an information retrieval site that requires authentication as a condition to respond search results;
reading means that read a script definition corresponding to the information retrieval site designated by the user terminal from said storage;
receiving means that receive certification from the information retrieval site by executing the authentication function when the script definition for the information retrieval site includes the authentication function;
converting means that convert the search condition designated by the user terminal into a search condition in compliance with a description rule of the information retrieval site by executing the conversion function in the script definition;
transmitting means that transmit a search request according to the converted search condition to the designated information retrieval site;
receiving means that receive search results from the information retrieval site that has retrieved information in response to said search request; and
transmitting means that transmit the received search results to the user terminal.
